(19) United States
(12) Patent Application Publication
(10) Pub. No.: US 2011/0076380 A1
(43) Pub. Date: Mar. 31, 2011

(54) METHOD OF MAKING A BAKED SNACK BASE PRODUCT AND THE SNACK BASE PRODUCT PRODUCED THEREBY

(75) Inventor: Andrew Dyhin, Dulwich Hill (AU)

(73) Assignee: POTATOMAGIC AUSTRALIA PTY LTD

(21) Appl. No.: 12/845,718

(22) Filed: Jul. 28, 2010

Related U.S. Application Data
(63) Continuation of application No. PCT/AU2009/000088, filed on Jan. 29, 2009.

(30) Foreign Application Priority Data
Jan. 29, 2008 (AU) 2008900394
Apr. 22, 2008 (AU) 2008901990

(51) Int. Cl. A23L 1/216; A23P 1/00; A23L 1/217; A23L 1/214

(52) U.S. Cl. 426/637; 426/519; 426/473; 426/438; 426/661

(57) ABSTRACT

Methods for processing a starch-based material are provided. Snack based products can be prepared using the methods herein.

### TECHNICAL FIELD

The present invention relates to a method of processing a starch-based material and a starch-based material processed by the method. In one embodiment, the invention relates to a method of making a low-fat snack base product and a low-fat snack base product produced thereby. In another embodiment, the invention relates to a method of making a low-fat potato crisp and the low-fat potato crisp produced thereby.

### BACKGROUND OF THE INVENTION

The information provided herein and references cited are provided solely to assist the understanding of the reader, and do not constitute an admission that any of the references or information is prior art to the present invention.

Snack food products such as potato chips form a popular part of the human diet. Most snack foods contain undesirable levels of ingredients introduced during the preparation process, one of these being high levels of fat. It is well recognised that there is a correlation between the amount of fat in the diet and the risk of developing life threatening diseases and obesity. Snack foods have become a significant contributor to calories and fats consumed daily by the public.

To date, there are a number of ways to produce potato crisps and other similar snack food products. There include “potato chips” made by frying or baking potato slices and “fabricated potato type” prepared by frying or baking a sheeted dough.

In the conventional production of potato chips, raw or blanched potato slices are deep fried in oil or fat to yield the final potato chip product. The effect of frying the potato slice is to reduce the water content with consequent oil uptake and to produce surface colour and crispness. The final potato chip product typically contains from 30 to 40 wt % oil or fat based on the total weight of the potato chip and less than 5 wt % water. Apart from the nutritionally undesirable amounts of oil and fat present, the deep fat frying process also shortens the shelf stability of the potato chip and can also result in overcooked potato chips.

With increased public awareness as to the benefits of low fat foods, efforts have been undertaken to develop alternate methods for producing potato-based snack food products, which have substantially the same flavour, colour and crispness to conventional deep-fried products but with a lower fat content.

Heating or drying of potato slices in which substantially no fat content is added and no foodstuff is removed has been achieved by a variety of procedures such as by the use of periodic microwave heating, high-intensity infrared heating, electromagnetic heating and use of long wavelength radiofrequency electromagnetic waves (see for example, Petelle et al. U.S. Pat. No. 5,470,600; Benson et al. U.S. Pat. No. 5,802,929; and Greenway et al. U.S. Pat. No. 5,952,026). These processes result in manufacture of low-fat potato snack products but often fail in emulating the texture of oil-fried potato crisps.

Use of opposed heated surfaces in the manufacture or waffles and wafers is also known. These processes usually use batters prepared from cereal flours but there have been attempts to obtain protein-free waffles (with no flour, egg, etc.). An example is a patent by Salsa GB 1,443,733, which describes the use of stabilized starch dispersions to prepare protein-free waffles.

Use of a toasting process by compressive opposed contact surfaces is also disclosed by Childers et al. in U.S. Pat. No. 4,919,965. In this patent slices of agricultural produce were toasted resulting in a crisp and fat-free chip.

Use of pressurized surfaces can result in a product that has desired crispiness but does not have the structure with comparable amount of voids, which is normally obtained by replacing water by oil and air, such as in a conventional manufacture of potato crisps.

Similar use of a pair of opposing pressurizing surfaces is disclosed by Takeo et al. in Taiwanese Pat. Applic. No. TW258337B, in which material comprising bread was heated under pressure with resulting texture of the processed product being close to that of potato chips. Another attempt to mimic the texture, structure and appearance of conventional potato chips was disclosed by Bosch et al. in U.S. Pat. Applic. No US2005202125, which teaches a process for preparing a snack food product made from dough, which is formed into sheets that are then folded, shaped and dried.

The products produced by these methods are not always satisfactory. In addition, the processes are often dependent on the characteristics of gluten and/or use of other additives in order to obtain the desired structure. Gluten network, in which individual starch granules are entrapped, is a key factor in achieving the desired texture of baked products by entrapping moisture and air during the baking process.

Nevertheless, there have been attempts to obtain stable structure of starch based-products without being dependent on gluten or other protein source in providing structural integrity to the product. As an example, a thermoforming process for starch products between two heating plates is described by Tsiapouris et al. (2001) (Eng. Life Sci., 1 (6), 229-232). The “baking process” described involves gelatinization, gel formation, water evaporation, solidification, crust formation and drying. The starting material in this process is a suspension of potato starch in water. The resulting product has a brittle, glassy texture with limited use in food industries that require a typical crunchy texture similar to conventional potato chips/crisps.

Glassy or brittle texture is undesirable in products such as potato crisps. Therefore, there have been attempts to achieve a non-brittle structure from a starch-based material. As an example, U.S. Pat. Applic. 2006193959 describes a method for manufacturing a low-calorie non-brittle starch based product by injection molding. The starting material is a comestible body that contains binder in the form of pregelatinized starch or pre-cooked flour and the process disclosed results in an extruded product dissimilar to conventional potato chips.

It would be desirable to provide a snack food product, which in one embodiment is lower in fat than conventional deep fried products, and has a texture and taste similar to conventional snack food products such as a potato chip or cracker.

### SUMMARY OF THE INVENTION

According to a first aspect of the present invention, there is provided a method of processing a starch-based material comprising:

providing a substantially gelatinized starch-based material;

forming the gelatinized starch-based material into a mash; and

baking portion(s) of the mash between an opposed pair of heated surfaces and under initial compression to produce a baked starch-based product.

According to a second aspect of the present invention, there is provided a starch-based product produced by the method of the first aspect of the invention.

According to a third aspect of the present invention, there is provided a method of processing a starch-based material comprising:

cooking the starch-based material;

mashing the cooked starch-based material to form a mash;

baking portion(s) of the mash between an opposed pair of heated surfaces and under initial compression to produce a baked potato product,

wherein the mash has a stickiness which enables the mash to stick to the pair of opposed heated surfaces when it comes into physical contact therewith.

According to a fourth aspect of the present invention, there is provided a baked potato product produced by the method of the third aspect.

### Definitions

The following are some definitions that may be helpful in understanding the description of the present invention. These are intended as general definitions and should in no way limit the scope of the present invention to those terms alone, but are put forth for a better understanding of the following description.

Unless the context requires otherwise or specifically stated to the contrary, integers, steps or elements of the invention recited herein as singular integers, steps or elements clearly encompass both singular and plural forms of the recited integers, steps or elements.

Throughout this specification, unless the context requires otherwise, the word “comprise”, or variations such as “comprises” or “comprising”, will be understood to imply the inclusion of a stated step or element or integer or group of steps or elements or integers, but not the exclusion of any other step or element or integer or group of elements or integers. Thus, in the context of this specification, the term “comprising” means “including principally, but not necessarily solely”.

By low-fat is meant that the starch base product contains a total fat content of 3 g or less per 100 g of product.

By gelatinised is meant collapse (disruption) of molecular order within the starch granule manifested in irreversible changes in properties such as granular swelling, native crystallite melting, loss of birefringence, and starch solubilisation. The temperature of initial gelatinisation and the range over which it occurs is dependent on starch concentration, granule type, and heterogeneities within the granule.

### DETAILED DESCRIPTION OF PREFERRED EMBODIMENTS OF THE INVENTION

The present invention relates to a method of processing a starch-based material comprising:

providing a substantially gelatinized starch-based material;

forming the gelatinized starch-based material into a mash; and

baking portion(s) of the mash between an opposed pair of heated surfaces and under initial compression to produce a baked starch-based product.

The invention also relates to a starch-based product produced by the method.

The starch-based material is suitably a raw starchy agricultural produce. In one embodiment the starch based material is typically, but not limited to potato, sweet potato, taro, sago or a mixture thereof. The agricultural produce may be peeled or unpeeled and washed. The agricultural produce may be a waste agricultural product. In one embodiment the starch-based material is gluten-free.

In one embodiment a whole fresh unpeeled potato is used to produce a potato crisp. In this embodiment, the method may involve cooking the whole potato with skin on; mashing the cooking potato to form a mash; baking portion(s) of the mash between an opposed pair of heated surfaces and under initial compression to produce a baked potato product, wherein the mash has a stickiness which enables the mash to stick to the pair of opposed heated surfaces when it comes into physical contact therewith.

The starch-based material may be provided pre-gelatinized/pre-cooked or may be gelatinized/cooked by heating for a time sufficient to swell the cells and substantially gelatinize starch granules and separate the cells from each other using methods known in the art. In one embodiment, the starch based material is heated for a time sufficient to swell and gelatinize at least 80% of the starch granules.

The cooked starch-based material is formed into a mash, suitably by reducing the particle size of the material. In one embodiment the particle size of the starch-based material is reduced to about 1 mm or less, typically 0.1 to 1 mm. The particle size can be reduced by application of a shear force such as by use of a typical hand mincer such as a commercial meat mincer. Alternatively a bowl cutter such as a Stephan 40Lt Vertical Bowl Cutter or Hobart bowl cutter may be used. In one embodiment gelatinization may occur simultaneously with forming into the mash. Typical moisture content of the mash is between 75 to 85 wt %, most typically 80 wt %.

Suitably the mash has a surface tension, consistency and viscoelastic properties (stickiness and cohesiveness) which enable the mash to stick to the pair of opposed heated surfaces when it comes into physical contact therewith. Ensuring the mash sticks to the heated surfaces allows the formation of a desirable pore structure within the product (without gluten) during baking by its ability to retain air and moisture during initial baking but allowing the baked product to be removed once the desired moisture level is obtained.

Viscoelastic parameters of the mash: the combination of stickiness (the balance between adhesive and cohesive forces), cohesiveness and surface tension are suitably selected so as to obtain a desired product having a desired structure. Viscoelastic properties of the mash are influenced by a number of aspects including genetic aspects (variety) and environmental aspects (growing season conditions) as well as the mashing process. Aspects known to influence the consistency of the mash and thereby the suitability for use in the present invention include specific gravity, sugar content, protein content, protein quality and solids content of the starch based material as well as the amylose content of the starch and the extent of retrogradation.

In one embodiment the mash may have specific gravity between 1.065 and 1.2.

In one embodiment the mash may have a sugar content of between 0 mg to 1000 mg/dL. In another embodiment, the sugar content may range between 20 and 300 mg/dL. In one embodiment the sugar content is such that acrylamide formation is minimised during processing so as to produce a product having superior colour.

In one embodiment the mash may have a protein content of between 2 and 3%.

In one embodiment the mash may have a solids content of between 17 and 23% w/w, for example about 20% w/w.

In one embodiment the amylose content of the starch present may be between 25 and 35 wt %, for example about 26 to 28 wt %. This content is desirable so as to minimise retrogradation (the alignment of starch molecules during the ageing of the gels).

Depending on the physicochemical characteristics of the starch-based material used such as specific gravity or sugar content, in one embodiment the processing parameters (temperature, pressure, time, continuous vs. batch process) can be altered to compensate for variations in these characteristics. It is thereby possible to process starch-based materials normally not suitable for processing into a baked product.

In one embodiment the viscoelasticity of the mash may suitably be such that it can hold a weight of 50 to 200 g, for example 160 g for 5 seconds measured using a modified Texture Profile Analyser (Texture Technologies, NY, USA). The modified Texture Profile Analyser comprises two opposed plates of a specified material and specified surface degree of polish and having a fixed bottom plate and a moveable upper plate. The upper plate is lowered and a gap of 1.3 mm between the plates is created. A weight is attached to the bottom plate of the instrument, suitably between 100 to 200 g, typically 160 to 180 g. In one embodiment a 160 g weight can be used. An amount of the material to be measured is placed onto the lower plate and compressed by the upper plate to the thickness of 1.3 mm. In one embodiment 5 to 6 g of mash can be used. The upper plate is then raised at a constant speed. A mash with optimal viscoelastic characteristics compressed between the plates can lift the bottom plate and hold it for a minimum time of about 5 seconds. If the mash pulls away from any of the plates during the lift of the upper plate or cannot hold the weight of the bottom plate with the attached weight for a minimum time of about 5 seconds, the combination of stickiness, adhesiveness and consistency of the mash may be unfavourable for processing.

In accordance with the invention, mash portion(s) are heated between an opposed pair of heated surfaces and under pressure/compression to drive out moisture and bake the portion. It was found that without this step where open air drying was used, the resulting product lacked characteristics typical for conventional snack products.

In one embodiment, the moisture content may be reduced during baking to about 5 wt % or less, for example 0.5 to 3.5 wt % or 1.5 wt % to 3.0 wt %. In this embodiment, the baked product may typically have a flat, cracker or wafer-like structure.

In another embodiment, the moisture content may be reduced to about 60 wt % or less, for example 40 to 60 wt % or 50 to 60 wt % or 15 wt % or less. In this embodiment, the elasticity of the baked product allows the product to optionally be further processed including shaping followed by drying to a moisture content of about 5 wt % of less, for example 0.5 to 3.5 wt % or 1.5 wt % to 3.0 wt %. In this embodiment, the baked and dried product may have a chip, crisp shape and structure closely resembling that of conventional deep-fried products.

In one embodiment, moisture content may be reduced after baking by means known in the art, such as hot-air drying, microwave heating, high-intensity infrared heating, electromagnetic heating and use of long wavelength radiofrequency electromagnetic waves.

In another embodiment, the moisture content may be reduced after baking by deep-frying in oil. Whilst deep-frying of the baked product in oil may result in the replacement of some water by oil resulting in a product having a higher fat content than an air-dried product, this product may still be desirable. Deep-frying enables the use of sub-optimal or waste material from other manufacturing processes using agricultural produce, in which the level of cohesiveness of the waste material may not be optimal to create the desired crispy texture. Baking mash from waste agriculture produce between opposing heated surfaces followed by deep frying in oil overcomes problems that prevent using such waste produce in the manufacture of high value crisps and other snack products. In other words, this process although not producing a product low in fat does provide profitable commercial outlet for process ‘waste’ from other product streams using the innovation disclosed in this patent.

In one embodiment, mash portion(s) are heated between an opposed pair of heated rollers and under pressure/compression to drive out moisture and shape and stabilize the mash portions. In another embodiment, mash portion(s) are heated between an opposed pair of heated rollers, where the gap between the rollers, stickiness of the mash and the surface characteristics of the rollers are matched so that individual mash portions stick to the rollers resulting in the subsequent separation of the mash portions, resulting in the production of two crisp-shaped portions from each portion of the mash. In another embodiment, mash portion(s) are heated between an opposed pair of heated moving belts. Following shaping and stabilizing, the moisture content of the mash portions may be reduced by means known in the art, including deep-frying in oil.

Being able to match the stickiness of the mash with the method of thermal formation of the product and the method of moisture reduction enables the present invention to use materials with other than optimal level of cohesiveness. As described above, the method of thermal formation may be typically, but not limited to, opposing heated surfaces, rollers or belts. Subsequent moisture content may be reduced typically, but not limited to, by hot-air drying, microwave heating, high-intensity infrared heating, electromagnetic heating or deep frying in oil. The combination of the processes described above can result in a wide variety of snack products that can be produced from a variety of agricultural produce.

In one embodiment the mash is fed through a dispensing outlet onto a heating element to form portions having a pre-defined volume. The dispensing outlet may form part of a depositor such as an air- or liquid-displacement depositor. In one embodiment the dispensing outlet forms part of a ratchet driven piping depositor with a 5 to 22 mm nozzle, for example a 10 mm nozzle to deposit portions of about 4 to 5 g size onto the heating element. The heating element is suitably formed of two hinged flat plates.

The aim of the step of heating and application of pressure is to obtain a product having a texture which simulates the texture of a conventional deep-fried product and may be achieved by providing the pair of opposed heating surfaces.

The level of adhesion of the mash to the heated surface can be controlled by modifying the viscoelastic properties of the mash as outlined above and/or by modifying the surface characteristics of one or both surfaces of the pair of opposed heating surfaces.

In one embodiment one, suitably both opposed heating surfaces are provided with a surface characteristics allowing the portion of the mash to stick/adhere to the surface to form the desired texture. In one embodiment at least one, suitably both of the opposed heating surfaces is provided with a smooth or textured surface.

In another embodiment, a specific material of construction with desired stick/non-stick characteristics can be used. Whilst the pair of opposing heated surfaces may contain a non-stick surface, in certain embodiments this is not desirable as it may not result in a product of desired structure (product would be typically hard and glossy). In one embodiment at least one, suitably both of the pair of opposed heating surfaces are made from cast iron.

In one embodiment a small amount of edible oil, fat or vegetable shortening may be applied to the surfaces of the heating element prior to baking. For example less than 2 wt %, or 0.01 to 2 wt % or 0.2 wt % per weight of the mash may be applied to the surface. Application of oil to the heated surfaces facilitates adherence of the mash to the heated surfaces in the initial stages of baking and facilitates the release of the product from the cooking surface after the structure is stabilised. Use of oil offers an advantage over the use of heating surfaces with specific stick/non-stick characteristics insofar as there is a possibility of ongoing process control where the viscoelastic properties of the mash vary. It is also believed that the small amount of oil interacts with the mash in such a way that it modifies the surface properties of the mash allowing the formulation of a desired structure.

In an alternative embodiment, the edible oil, fat or vegetable shortening may be directly added to the mash. This has similar effects as to applying oil to the surfaces of the heating element.

In one embodiment, at least one, suitably both surfaces of the pair of opposed heated surfaces are temperature and product-thickness controlled. The temperature and thickness used may vary depending on the moisture content and viscoelastic properties of the starch based material used as well as the desired parameter of the product. In one embodiment the temperature of the heated surface is about 100° C. to 350° C. during baking, for example 120° C. to 300° C., or 140° C. to 250° C. or 150° C. to 200° C. or 160° C. to 180° C.

In one embodiment, the pair of opposed heated surfaces are not moved in relation to each other during a period of the heating, suitably during an initial stage of baking. In one embodiment, the opposed heated surfaces are not moved in relation to each other for a period of at least 15 seconds, for example for a period of 15 up to 30 seconds, for a period of 15 up to 60 seconds, for a period of 15 up to 90 seconds or for the whole period of baking which may be 100 seconds up to 10 minutes, for example 2 to 3 minutes. By allowing the mash to stick/adhere to the opposed heating surfaces which are not moved in relation to each other during the initial period of baking results in the formation of a desirable pore structure thereby preventing collapse of the structure and stabilizing those parts of the mash that come into physical contact with the heated surfaces. During initial baking the exterior surfaces are baked rapidly and pores are developed with expansion, the material entrapping air and moisture in the interior thereby retaining elasticity. With further heating moisture is driven from the starch-based material as a result of the compressive force from the pair of opposed heated surfaces. As a result of the dynamic process of moisture escaping from the product while the starch is being stabilised by the applied heat makes it possible for the characteristic snack food structure to be formed. The level of collapse of the structure of the mash, the moisture content at which the product is removed, the amount of compressive force, temperature of the heated surfaces and distance between the surfaces allows control of the ratio of voids to solids within the final baked product. As the moisture content decreases during baking, the stickiness of the product decreases allowing the product to be removed from the surface at a desired moisture level.

In one embodiment the distance between the pair of opposed heated surfaces can be used to control the texture and mouth feel of the product. Using a smaller distance between the opposed surfaces results in a dense crunchy baked product, whereas a larger distance results in a lighter product. In one embodiment, the distance between the pair of opposed heating surfaces is between about 0.8 and 3.5 mm, for example about 1.5 mm to 2.5 mm. The distance between the pair of opposed surfaces can also be varied through the baking process. By increasing the distance between the heated surfaces after an initial period of baking, it is possible to modify the ratio of solids and voids within the structure of the baked product.

The resulting product has a texture and colour typical for snack products.

Additives such as seasonings, vitamins, spices, nutrients, preservatives and flavourings may be added at any point in the process including after manufacture. They can be blended into the mash or sprinkled onto the mash before baking or onto the baked product after baking. Additives may be included in amounts of 0-2 wt % of the final product. Suitable flavourings include cheese, simulated cheese, nacho, sour cream, salt, iodized salt, pepper, vinegar, barbecue, sour cream, onion, garlic, bacon, chicken, beef, ham, peanut butter, nuts and seeds, vanilla, chocolate and others. In one embodiment prior to forming into the mash or simultaneously with making the mash, the gelatinized/cooked starch based material may be combined with the additives.

The resulting product may be packaged using processes known in the art.

By the method it is possible in one embodiment to obtain a low-fat, for example less than 1 wt %, starch based product suitable for use in the snack food industry. The texture of the starch based product produced can simulate the texture of a conventional deep-fried product such as a potato chip or crisp, including crispness, a pleasing mouth feel, acceptable taste and textured appearance. The process of the invention has the additional advantage that it is possible to produce a baked product without the use of any additional additives aside from a small portion of edible oil and seasoning/flavouring/preservative agents as above. In addition the viscoelastic properties of the mash enable the product to have a desired structure even when the starch-based material is gluten-free.

The present invention overcomes texture problems suitably by using adhesion in combination with surface tension to provide a baked product of a desired porous structure. The present invention differs from previous processes intended to provide food products with a desired structure resembling deep-fried products by containing little or no gluten. Additionally, the present invention does not involve sheeting, which is a common step in the manufacture of fabricated snack products. It is possible by use of the invention to process a wide variety of starch based raw materials having variable properties with respect to sugar content.

Using starch suspensions in the present invention instead of the cooked potato mash typically results in the product with hard, chewy texture unacceptable in food products. Similarly, use of non-stick heated surfaces typically results in hard, collapsed structure, similar to rice crackers and similar products. Addition of water to the mash typically leads to decrease in solids to the extent that desired product is not formed at all due to insufficient cohesiveness of the mash.

The present invention is advantageous over existing processes in that it overcomes problems with the product texture as well as can remove steps such as peeling of the agricultural produce, isolating the starch from agricultural produce or preparing starch-based dough. This results in major energy and water savings, limits the use of additives and other ingredients and uses the agricultural produce to maximum possible extent, which results in limited waste compared to other processes.

Increased public demand for “simple” and “organic” products rather than “fabricated potato type” products brings the challenge of using whole potatoes with nothing removed and nothing added. This leaves processing conditions as the only variable in determining the structure of a final product. While cooking and mashing of potatoes are processes known in the art, modification of these processes can lead to the desired viscoelastic and textural properties of the product such as potato mash, where stickiness is often an issue. The way to decrease the stickiness of the potato mash in order to obtain material transportable by tubes and other machinery is disclosed by Gidley & Ormerod in EP 850570. Gidley et al. showed that by limiting post-gelatinization swelling of starch granules in cooked potatoes less glutinous and less sticky potato mash can be obtained.

In the present invention, it is possible to manufacture a potato crisp from 100% whole fresh potatoes (without removing the skin or adding any fat in the process) with texture and taste similar to conventional snack food products. Using cooking and mashing processes known in the art, the innovation is brought of characterizing viscoelastic properties of the mash and “matching” it with the characteristics of the used heating surfaces in order to provide optimal adhesion between the mash and the surfaces supporting the drying mash during baking, which results in the mouth-feel and texture of is the product similar to conventional potato chip.

The invention will now be described by way of example only having regard to the following examples.

### EXAMPLE 1

2.5 kg of unpeeled or peeled cooked potato was formed into a mash by use of a hand mincer at 60° C. The resulting mash was loaded into a ratchet driven piping depositor with a 10 mm nozzle. A set of cast iron temperature-controlled hinged flat plates 240 mm×240 mm with an approach gap of 1.5 mm was preheated to 160° C. The depositor was used to deposit 4 mash deposits of 5 to 6 g each onto the bottom plate and the plate closed. After 120 seconds the plates were separated and the pure baked potato product was then removed, cooled and bagged in hermetically sealed bags for consumption as a snack food.

### EXAMPLE 2

2.5 kg of unpeeled or peeled cooked potato was formed into a mash using a Hobart bowl cutter for 6 minutes at 60° C. together with 4 g of iodized salt. The resulting mash was loaded into a ratchet driven piping depositor with a 10 mm nozzle. A set of cast iron temperature controlled hinged flat plates 240 mm×240 min with an approach gap of 1.5 mm was preheated to 160° C. The depositor was used to deposit 4 mash deposits of 5 to 6 g each onto the bottom plate. The plates were then closed. After 120 seconds, the plates were separated and the salt baked potato product was then removed, cooled and bagged in hermetically sealed bags for consumption as snack food.

### EXAMPLE 3

2.5 kg of unpeeled or peeled cooked potato was formed into a mash using a Hobart bowl cutter for 6 minutes at 60° C. together with 4 g of iodized salt. The resulting mash was loaded into a ratchet driven piping depositor with a 10 mm nozzle. A set of cast iron temperature controlled hinged flat plates 240 mm×240 mm with an approach gap of 1.5 mm was preheated to 160° C. The depositor was used to deposit 16 mash deposits of 5 to 6 g each onto the bottom plate. The plates were then closed. After 100 seconds, the plates were separated and the baked potato product was then removed. The baked product was then dried in a fan forced oven at 106° C. for 35 minutes. The dried baked product was removed from the dryer and sprayed with a water mist carrying seasoning and/or salt mixture at a rate of 6 g/kg for seasoning and salt or 3.2 g/kg for salt alone. The seasoned dried baked product was then returned to the drier and dried for 2 minutes, cooled and bagged in hermetically sealed bags for consumption as snack food.

The foregoing description of a preferred embodiments and best mode of the invention known to the applicant at the time of filing the application have been presented for the purposes of illustration and description. It is not intended to be exhaustive or to limit the invention to the precise form disclosed. Many modifications and variations are possible in the light of the above teaching. The embodiments were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

1. A method of processing a starch-based material comprising:
providing a cooked or substantially gelatinized starch based material;
forming the starch-based material into a mash; and
baking portion(s) of the mash between an opposed pair of heated surfaces and under initial compression to produce a baked starch-based product.

2. (canceled)

3. A method according to claim 1 wherein the starch-based material is potato, sweet potato, taro, sago or a mixture thereof.

4. A method according to claim 1 wherein the particle size of the mash is 1 mm or less.

5. A method according to claim 1 wherein the mash has a surface tension, consistency and viscoelastic properties which enable the mash to stick to the pair of opposed heated surfaces when it comes into physical contact therewith.

6. A method according to claim 1 wherein the mash has a specific gravity between 1.065 and 1.2.

7. A method according to claim 1 wherein the viscoelasticity of the mash is such that it can hold a weight of 50 to 200 g for 5 seconds measured using a modified Texture Profile Analyser.

8. A method according to claim 7 wherein the viscoelasticity of the mash is such that it can hold a weight of 160 g for 5 seconds measured using a modified Texture Profile Analyser.

9. A method according to claim 1 wherein the moisture content is reduced during baking to about 5 wt % or less.

10. A method according to claim 1 wherein the moisture content is reduced during baking to about 40-60 wt % or less.

11. A method according to claim 10 wherein the baked product is shaped and dried to a moisture content of 5 wt % or less.

12. A method according to claim 10 wherein the baked product is deep-fried with the resulting product having a moisture content of 5 wt % or less.

13. A method according to claim 1 wherein one or both opposed heating surfaces are provided with a surface characteristic allowing the portion of the mash to stick/adhere to the surface.

14. A method according to claim 1 wherein one or both opposed heating surfaces are made from cast iron.

15. A method according to claim 1 wherein the pair of opposed heated surfaces are not moved in relation to each other during an initial period of the baking.

16. A starch-based product produced by the method of claim 1.
